(19) United States
(12) Patent Application Publication
(10) Pub. No.: US 2004/0130412 A1
(43) Pub. Date: Jul. 8, 2004

(54) Resonator, filter, communication apparatus, resonator manufacturing method and filter manufacturing method

(76) Inventors: Takehiko Yamakawa, Osaka (JP); Toshio Ishizaki, Hyogo (JP); Makoto Fujikawa, Nara (JP); Ikuo Awai, Yamaguchi (JP)

Correspondence Address: RATNERPRESTIA, P O BOX 980, VALLEY FORGE, PA, 19482-0980, US

(21) Appl. No.: 10/676,404

(22) Filed: Oct. 1, 2003

(30) Foreign Application Priority Data
Oct. 4, 2002 (JP) 2002-292937

(51) Int. Cl. H01P 1/213; H01P 1/20; H01P 7/10

(52) U.S. Cl. 333/134; 333/202; 333/219.1

(57) ABSTRACT

A resonator having a dielectric element, a metal housing accommodating the dielectric element, and a low relative permittivity material holding the dielectric element so as to have a predetermined clearance generated between a dielectric element surface of the dielectric element to which a generated electric field is substantially orthogonal and a housing surface of the metal housing opposed to the dielectric element surface.

### BACKGROUND OF THE INVENTION

1. Field of the Invention

The present invention relates to a resonator, a filter, a communication apparatus, a resonator manufacturing method and a filter manufacturing method used for filters of base station equipment of a mobile communication base station of portable telephones and the like and an airwave sending station and so on, and for those of terminals.

2. Related Art of the Invention

In recent years, sensitive sending and receiving performance and good call quality are essential to a portable telephone system, and filters of base station equipment and terminals are required to have a passage characteristic of low losses hardly degrading signal components and a precipitous attenuation characteristic capable of securely eliminating an unnecessary disturbing wave component.

Furthermore, there is increasingly severe demand for miniaturization lately in addition to the demand for such high performance.

As for the filter meeting such demand, there is a TE_{01δ}, mode dielectric filter using a dielectric resonator of a high value Q (quality factor).

Hereafter, a description will be given by referring to the drawings as to small dielectric resonators in the past and dielectric filters using them.

FIG. 12(a) shows a D-D′ cross-sectional view of a TE_{01δ}, mode dielectric resonator in the past, and FIG. 12(b) shows a right side view thereof.

Reference numerals 1001a and 1001b denote input-output terminals, 1002a and 1002b denote input-output probes, 1003 denotes a dielectric element comprised of a ceramic and so on, 1004 denotes a metal housing, 1005 denotes a support made of alumina which is a low relative permittivity material having a good high-frequency characteristic.

The input-output probes 1002a and 1002b are connected to central conductors of the input-output terminals 1001a and 1001b by soldering and so on respectively.

The dielectric element 1003 is cylindrical, and is glued to the metal housing 1004 via the support 1005 so as to be located approximately at the center of the metal housing 1004.

A signal inputted to the input-output terminal 1001a is outputted from the input-output terminal 1001b via an electromagnetic coupling between the input-output probe 1002a and the dielectric element 1003 and the electromagnetic coupling between the dielectric element 1003 and the input-output probe 1002b.

Here, as shown in FIG. 18 which is an explanatory diagram of electromagnetic field distribution generated on the dielectric resonator in the past, electric fields (indicated in full line) are concentratedly generated inside the dielectric element 1003, and magnetic fields (indicated in broken line) are generated to be orthogonal thereto.

Thus, the characteristic as the TE_{01δ}, mode dielectric resonator can be obtained.

As for the above configuration in the past, however, there were the cases where the shape of the apparatus became larger than a required size.

FIG. 13 shows a sectional view of the TE_{01δ} mode dielectric resonator in the past which further miniaturized the TE_{01δ} mode dielectric resonator in FIG. 12.

In FIG. 13, reference numerals 1001a and 1001b denote the input-output terminals, 1102a and 1102b denote the input-output probes, 1103 denotes the dielectric element, and 1104 denotes the metal housing.

The input-output probes 1102a and 1102b are connected to the central conductors of the input-output terminals 1101a and 1101b by soldering and so on respectively.

The dielectric element 1103 has a half-cylindrical shape obtained when a cylindrical shape is severed by a plane including its central axis, and a side which is a non-semicircular rectangular plane is placed to be directly in contact with the metal housing 1104.

The signal inputted to the input-output terminal 1101a is outputted from the input-output terminal 1101b via the electromagnetic coupling between the input-output probe 1102a and the dielectric element 1103 and the electromagnetic coupling between the dielectric element 1103 and the input-output probe. 1102b.

Thus, the characteristic as the TE_{01δ} mode dielectric resonator can be obtained.

FIG. 14(a) shows an E-E′ cross-sectional view of the dielectric resonator constituting a TE_{01δ} mode dielectric filter in the past, and FIG. 14(b) shows a right side view thereof.

Such a dielectric resonator is a four-stage filter having connected four TE_{01δ} mode dielectric resonators in FIG. 13.

In FIG. 14, reference numerals 1201a and 1201b denote the input-output terminals, 1202a and 1202b denote the input-output probes, 1203a, 1203b, 1203c and 1203d denote the dielectric element s, and 1204 denotes the metal housing.

The input-output probes 1202a and 1202b are connected to the central conductors of the input-output terminals 1201a and 1201b by soldering and so on respectively.

The dielectric elements 1203a, 1203b, 1203c and 1203d have the half-cylindrical shape, and the side which is a non-semicircular plane is directly in contact with the metal housing 1204.

The signal inputted to the input-output terminal 1201a is outputted from the input-output terminal 1201b via the electromagnetic coupling between the input-output probe 1202a and the dielectric element 1203a, the electromagnetic coupling between the dielectric element 1203a and the dielectric element 1203b, the electromagnetic coupling between the dielectric element 1203b and the dielectric element 1203c, the electromagnetic coupling between the dielectric element 1203c and the dielectric element 1203d, and the electromagnetic coupling between the dielectric element 1203d and the input-output probe 1202b.

Thus, the characteristic as a band pass filter can be obtained (refer to Patent Application Laid-Open No. 57-14201 and Patent Application Laid-Open No. 57-14202).

Here, the entire disclosures of Patent Application Laid-Open No. 57-14201 and Patent Application Laid-Open No. 57-14202 are incorporated herein by reference in its entirety.

In the case of using a dielectric element 1203 smaller than a dielectric element 1003, however, the non-half-cylindrical plane is directly in contact with the metal housing 1204 so that conductor losses will increase.

For this reason, there are the cases where a value Q of a dielectric resonator decreases and losses increase so that its performance is degraded.

An object of the present invention is to provide a resonator, a filter and a communication apparatus which are small and high-Q, and a resonator manufacturing method and a filter manufacturing method thereof in consideration of the above problems in the past.

The present invention is useful because it can provide the resonator, filter and communication apparatus which are small and high-Q, and the resonator manufacturing method and filter manufacturing method thereof.

### SUMMARY OF THE INVENTION

The 1^{st} aspect of the present invention is a resonator having:

a dielectric element;

a housing of accommodating said dielectric element; and

a holding member of holding said dielectric element so as to have a predetermined clearance generated between a dielectric element surface of said dielectric element to which a generated electric field is substantially orthogonal and a housing surface of said housing opposed to the dielectric element surface.

The 2^{nd} aspect of the present invention is the resonator according to the 1^{st} aspect of the present invention, wherein said dielectric element is the dielectric element operating in a TE mode; and

said electric field is the electric field operating in said TE mode.

The 3^{rd} aspect of the present invention is the resonator according to the 1^{st} aspect of the present invention, wherein said holding member is the holding member formed in said predetermined clearance by utilizing a predetermined low relative permittivity material.

The 4^{th} aspect of the present invention is the resonator according to the 1st aspect of the present invention, wherein:

said dielectric element has a half-cylindrical shape obtained when a cylindrical shape is severed by a plane including its central axis; and

said dielectric element surface is a surface severed by said plane.

The 5^{th} aspect of the present invention is the resonator according to the 4^{th} aspect of the present invention, further having signal input-output probes of inputting and outputting a signal provided by utilizing a housing surface on which said dielectric element is held.

The 6^{th} aspect of the present invention is the resonator according to the 1^{st} aspect of the present invention, wherein:

said dielectric element has a quarter-cylindrical shape obtained when a cylindrical shape is severed by two mutually orthogonal planes including its central axis; and

said dielectric element surface is two surfaces severed by said two planes.

The 7^{th} aspect of the present invention is the resonator according to the 6^{th} aspect of the present invention, wherein said dielectric element is held by utilizing two adjacent housing surfaces of said housing, and further having signal input-output probes of inputting and outputting a signal provided by utilizing one of said two adjacent housing surfaces.

The 8^{th} aspect of the present invention is the resonator according to the 4^{th} or the 6^{th} aspects of the present invention, wherein said cylindrical shape has a hole at the center thereof.

The 9^{th} aspect of the present invention is the resonator according to the 1^{st} aspect of the present invention, wherein:

said dielectric element has a polygonal shape obtained when a polygonal shape is severed by a plane; and

said dielectric element surface is a surface severed by said plane.

The 10^{th} aspect of the present invention is the resonator according to the 9^{th} aspect of the present invention, further having signal input-output probes of inputting and outputting a signal provided by utilizing a housing surface on which said dielectric element is held.

The 11^{th} aspect of the present invention is a filter having:

a plurality of dielectric elements;

a housing of accommodating said dielectric elements; and

one or a plurality of holding members of holding said dielectric elements so as to have a predetermined clearance generated between dielectric element surfaces of said dielectric elements to which a generated electric field is substantially orthogonal and a housing surface of said housing opposed to the dielectric element surfaces.

The 12^{th} aspect of the present invention is the filter according to the 11^{th} aspect of the present invention, wherein said dielectric elements are the dielectric elements operating in a TE mode; and

said electric field is the electric field generated in said TE mode.

The 13^{th} aspect of the present invention is the filter according to the 11^{th} aspect of the present invention, wherein said holding member is the holding member formed in said predetermined clearance by utilizing a predetermined low relative permittivity material.

The 14^{th} aspect of the present invention is the filter according to the 11^{th} aspect of the present invention, wherein said holding members are the holding members holding two or more of said dielectric elements in common.

The 15^{th} aspect of the present invention is the filter according to the 11^{th} aspect of the present invention, wherein:

said dielectric elements have a half-cylindrical shape obtained when a cylindrical shape is severed by a plane including its central axis; and

said dielectric element surfaces are the surfaces severed by said plane.

The 16^{th} aspect of the present invention is the filter according to the 15^{th} aspect of the present invention, further having signal input-output probes of inputting and outputting a signal provided by utilizing a housing surface on which said dielectric elements are held.

The 17^{th} aspect of the present invention is the filter according to the 11^{th} aspect of the present invention, wherein:

said dielectric elements have a quarter-cylindrical shape obtained when a cylindrical shape is severed by two mutually orthogonal planes including its central axis; and

said dielectric element surface is two surfaces severed by said two planes.

The 18^{th} aspect of the present invention is the filter according to the 17^{th} aspect of the present invention, wherein said dielectric elements are held by utilizing two adjacent housing surfaces of said housing, and further having signal input-output probes of inputting and outputting a signal provided by utilizing one of said two adjacent housing surfaces.

The 19^{th} aspect of the present invention is the filter according to the 15^{th} or the 17^{th} aspects of the present invention, where in said cylindrical shape has a hole at the center thereof.

The 20^{th} aspect of the present invention is the filter according to the 1^{th} aspect of the present invention, wherein:

said dielectric elements have a polygonal pole shape obtained when a polygonal pole shape is severed by a plane; and

said dielectric element surfaces are the surfaces severed by said plane.

The 21^{th} aspect of the present invention is the filter according to the 20^{th} aspect of the present invention, further having a signal input-output probes of inputting and outputting a signal provided by utilizing a housing surface on which said dielectric elements are held.

The 22^{nd} aspect of the present invention is a communication apparatus having:

sending/receiving means of performing sending and/or receiving; and

the resonators according to the 1^{st} aspect of the present invention or the filters according to the 11^{th} aspect of the present invention of filtering a sending signal to be utilized for said sending and/or a receiving signal to be utilized for said receiving.

The 23^{rd} aspect of the present invention is a resonator manufacturing method having a holding member formation step of forming a holding member of holding a dielectric element so as to have a predetermined clearance generated between a dielectric element surface of said dielectric element to which a generated electric field is substantially orthogonal and a housing surface of a housing of accommodating said dielectric element opposed to the dielectric element surface.

The 24^{th} aspect of the present invention is a filter manufacturing method having a holding member formation step of forming one or a plurality of holding members of holding a plurality of dielectric elements so as to have a predetermined clearance generated between dielectric element surfaces of said dielectric elements to which a generated electric field is substantially orthogonal and a housing surface of a housing of accommodating said dielectric elements opposed to the dielectric element surfaces.

### BRIEF DESCRIPTION OF THE DRAWINGS

FIG. 1(a) is a perspective view of a dielectric resonator according to a first embodiment of the present invention;

FIG. 1(b) is an A-A′ sectional view of the dielectric resonator according to the first embodiment of the present invention;

FIG. 2 is a graph of a value Q and a resonance frequency of the lowest mode of the dielectric resonator against a space between a dielectric element and a metal housing of the dielectric resonator according to the first embodiment of the present invention;

FIG. 3 is the A-A′ sectional view of the dielectric resonator according to the first embodiment of the present invention;

FIG. 4(a) is a sectional view showing a (first) variant of the first embodiment of the present invention;

FIG. 4(b) is a sectional view showing a (second) variant of the first embodiment of the present invention;

FIG. 5(a) is a perspective view of the dielectric resonator according to a second embodiment of the present invention;

FIG. 5(b) is a B-B′ sectional view of the dielectric resonator according to the second embodiment of the present invention;

FIG. 6(a) is a sectional view showing a (first) variant of the second embodiment of the present invention;

FIG. 6(b) is a sectional view showing a (second) variant of the second embodiment of the present invention;

FIG. 7 is a sectional view of the dielectric resonator of a variant of the second embodiment of the present invention;

FIG. 8 is a graph of the value Q and the resonance frequency of the lowest mode of the dielectric resonator against the space between the dielectric element and the metal housing of the dielectric resonator according to the second embodiment of the present invention;

FIG. 9(a) is a C-C′ cross-sectional view of a dielectric filter according to a third embodiment of the present invention;

FIG. 9(b) is a right side view of the dielectric filter according to the third embodiment of the present invention;

FIG. 10 is a perspective view of the dielectric filter according to a fourth embodiment of the present invention;

FIG. 11 is a perspective view showing a variant of the fourth embodiment of the present invention;

FIG. 12(a) is a D-D′ cross-sectional view of the dielectric resonator in the past;

FIG. 12(b) is a right side view of the dielectric resonator in the past;

FIG. 13 is a sectional view of the dielectric resonator in the past;

FIG. 14(a) is an E-E′ cross-sectional view of the dielectric filter in the past;

FIG. 14(b) is a right side view of the dielectric filter in the past;

FIG. 15 is a sectional view of the dielectric resonator according to a fifth embodiment of the present invention;

FIG. 16 is a sectional view of the dielectric resonator according to the embodiment of the present invention;

FIG. 17 is a block diagram of a communication apparatus according to a sixth embodiment of the present invention;

FIG. 18 is an explanatory diagram of electromagnetic field distribution generated on the dielectric resonator in the past; and

FIG. 19 is an explanatory diagram of the electromagnetic field distribution generated on the dielectric resonator according to the fifth embodiment of the present invention.

Description of Symbols

101a, 101b Input-output terminals

102a, 102b Input-output probes

103 Dielectric element

104 Metal housing

301 Low relative permittivity material

401 Dielectric element

402 Metal housing

403a, 403b Low relative permittivity material

501 Metal housing

502 Metal housing

701a, 701b Input-output terminals

702a, 702b Input-output probes

703a, 703b, 703c, 703d Dielectric element

704 Metal housing

705 Low relative permittivity material

801a, 801b Input-output terminals

802a, 802b Input-output probes

803a, 803b, 803c, 803d Dielectric element

804 Metal housing

805a1, 805b1, 805c1, 805d1, 805a2, 805b2, 805c2, 805d2 Low relative permittivity material

901a, 901b Low relative permittivity material

1001a, 1001b Input-output terminals

1002a, 1002b Input-output probes

1003 Dielectric element

1004 Metal housing

1005 Support

1101a, 1101b Input-output terminals

1102a, 1102b Input-output probes

1201a, 1201b Input-output terminals

1202a, 1202b Input-output probes

1203a, 1202b, 1203c, 1202d Dielectric element

1204 Metal housing

### PRFERRED EMBODIMENTS OF THE INVENTION

Hereafter, the embodiments of the present invention will be described by referring to the drawings.

(First Embodiment)

To begin with, a dielectric resonator according to a first embodiment of the present invention will be described by referring to the drawings. An embodiment of a resonator manufacturing method of the present invention will also be described while describing the dielectric resonator according to this embodiment (same hereafter).

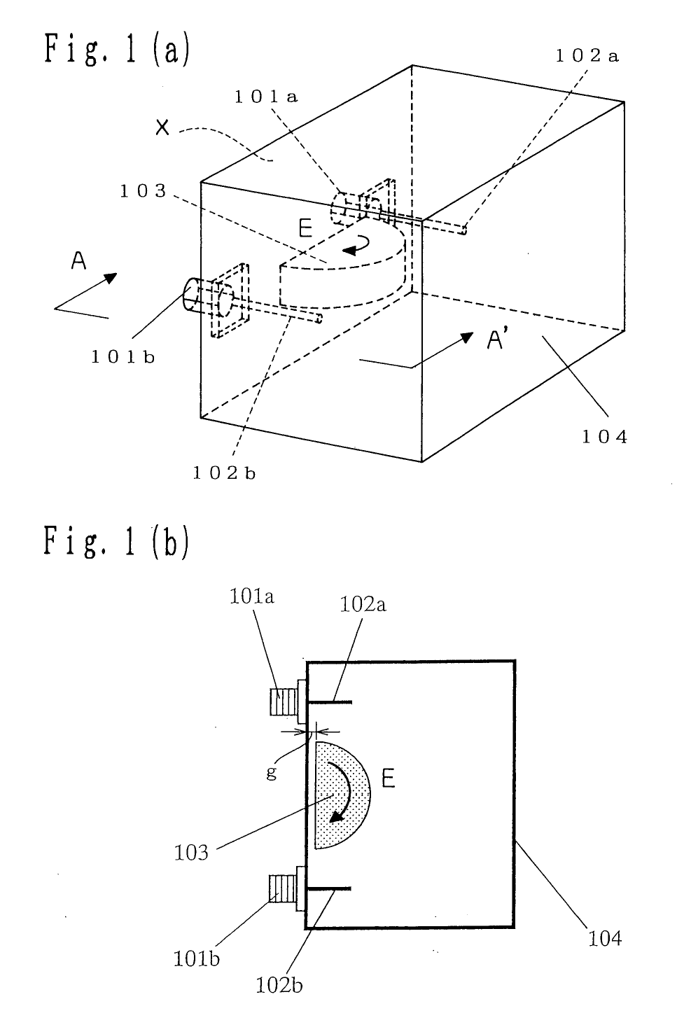

FIG. 1(a) shows a perspective view of the dielectric resonator according to the first embodiment of the present invention, and FIG. 1(b) is an A-A′ cross-sectional view thereof.

In FIGS. 1(a) and (b), reference numerals 101a and 101b denote input-output terminals, 102a and 102b denote input-output probes, 103 denotes a dielectric element, and 104 denotes a metal housing.

The input-output terminals 101a and 101b have the input-output probes 102a and 102b connected to central conductors thereof by soldering and so on, and are provided on a housing surface X on which the dielectric element 103 is held (same hereafter).

The dielectric element 103 has a half-cylindrical shape, and the side which is a non-semicircular rectangular plane is placed in the metal housing 104 with a fixed space g. The dielectric element 103 is made of a ceramic and so on.

To be more specific, a predetermined clearance is generated between the dielectric element surface X of the dielectric element 103 to which an electric field E is substantially orthogonal and the housing surface of the metal housing 104 opposed to the dielectric element surface.

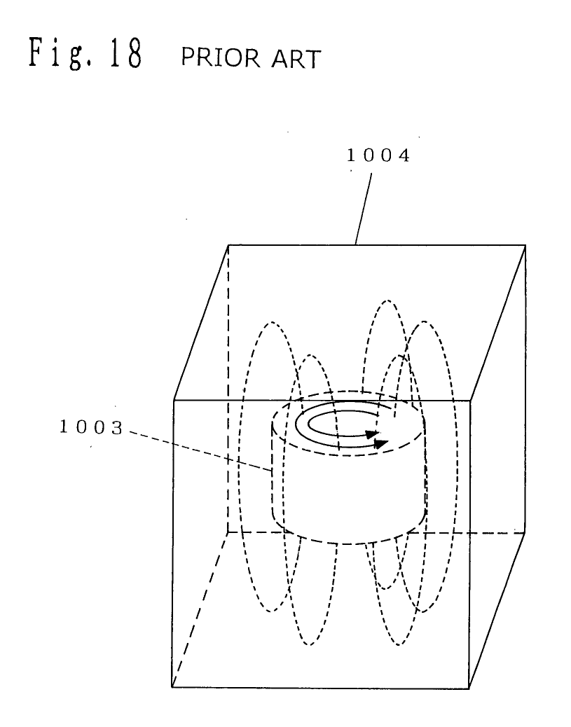

Here, the electric fields E are concentratedly generated inside the dielectric element 103 and at the fixed space g (refer to FIG. 18 relating to the embodiment 5).

The cylindrical shape according to this embodiment is a short shape, that is, a so-called a disc shape (same hereafter).

Operation of a dielectric filter constituted as above will be described.

The signal inputted to the input-output terminal 101a is outputted from the input-output terminal 101b via the electromagnetic coupling between the input-output probe 102a and the dielectric element 103 and the electromagnetic coupling between the dielectric element 103 and the input-output probe 102b.

Thus, a characteristic as the TE_{01δ}, mode dielectric resonator can be obtained.

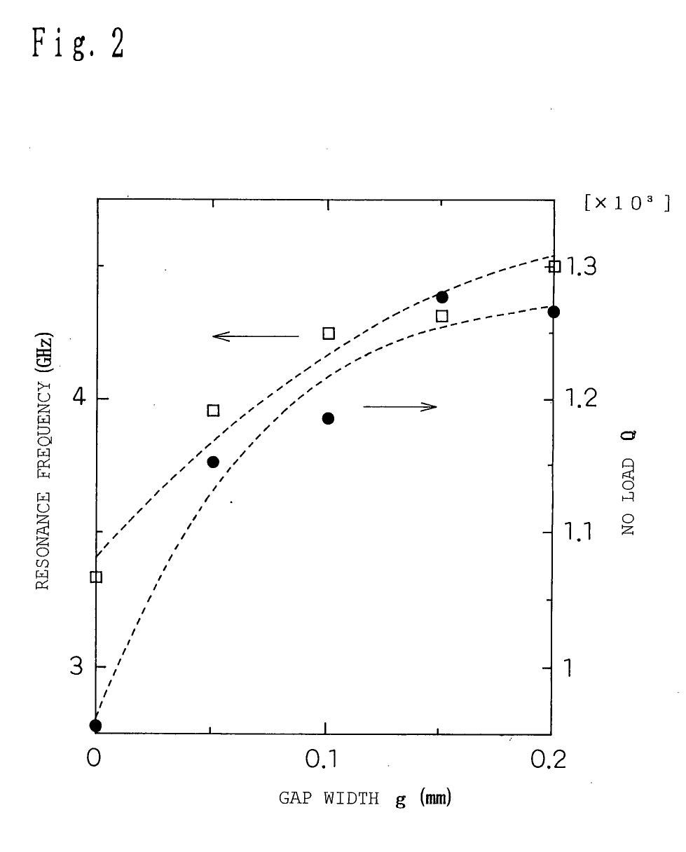

FIG. 2 is a graph (marked by black circles) plotting a relationship between a space g between the dielectric element 103 and the metal housing 104 and a value Q of the TE_{01δ}, mode dielectric resonator and a graph (marked by black squares) plotting a relationship between the space g and a resonance frequency of the TE_{01δ} mode dielectric resonator, according to the first embodiment of the present invention.

As is understandable from this, the value Q of the resonator is increased by providing the space g between the half-cylindrical dielectric element 103 suited to miniaturization and the metal housing 104. In the case where the space g is small, the rise in the value Q is small and frequency variation is significant so that the space g should preferably be set a little larger than 0.2 mm at which there is a little frequency variation.

Dimensions of the half-cylindrical dielectric element 103 are radius 5 mm, thickness 5.8 mm, and relative permittivity 93, and internal size of the metal housing 104 is length 21.4 mm, height 13.1 mm, and width 10.0 mm.

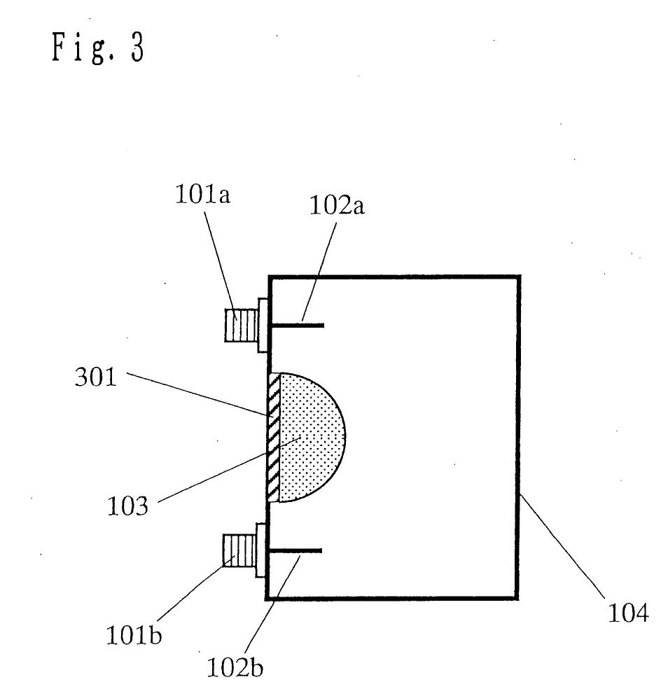

To hold the dielectric element 103, it is possible to utilize a support 1005 and so on. It is also possible, however, to place a low relative permittivity material 301 made of alumina or the like in the space g between a side of the dielectric element 103 which is a non-semicircular rectangular plane and the metal housing 104 as in FIG. 3 which is an A-A′ sectional view of the dielectric resonator according to the first embodiment of the present invention (that is, to support the low relative permittivity material 301 between the half-cylindrical dielectric element 103 and the metal housing 104). Thus, it becomes easy to exactly position and fix the dielectric element 103 in the metal housing, and it becomes possible to enhance a radiation effect of the dielectric element 103.

As a matter of course, the dielectric element 103 corresponds to the dielectric element of the present invention, the metal housing 104 corresponds to the housing of the present invention, the low relative permittivity material 301 corresponds to the holding member of the present invention, the input-output probes 102a and 102b correspond to signal input-output probes of the present invention. The dielectric resonator according to this embodiment corresponds to the resonator of the present invention.

The low relative permittivity material 301 is supported by the entire surface of the side which is the non-semicircular rectangular plane. However, it may be supported by a part thereof.

According to this embodiment, the metal housing 104 has a rectangular solid shape. It is sufficient, however, to have the side, which is the non-semicircular rectangular plane, opposed to the metal housing 104, and so it may be the half-cylindrical shape, for instance.

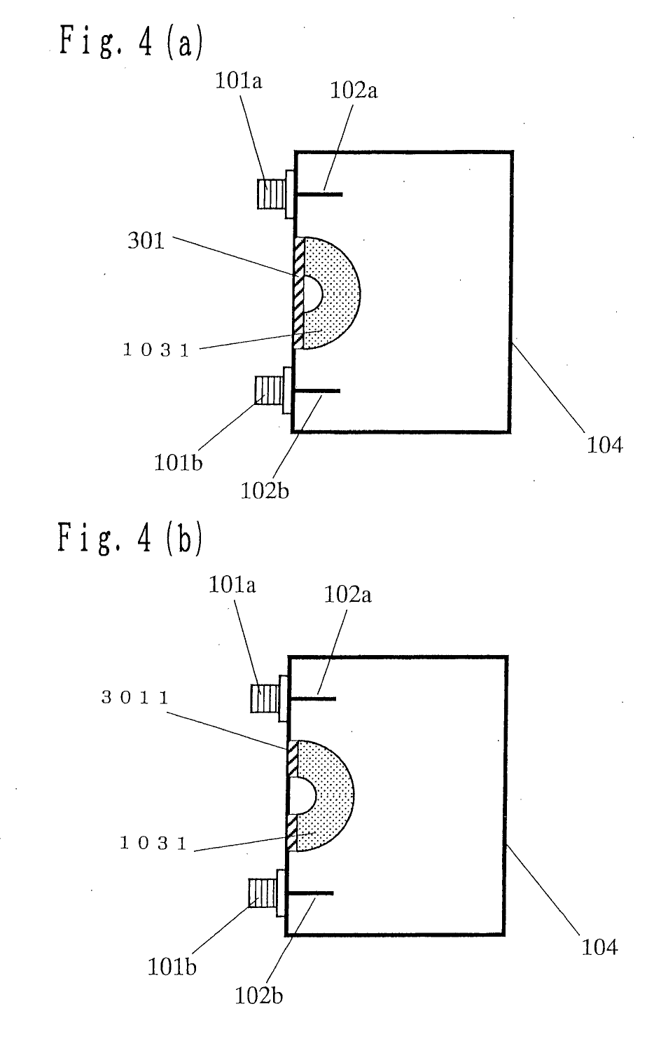

As shown in FIG. 4(a), a dielectric element 1031 may have a shape of a doughnut or a baumkuchen cut in half. In short, there may be a hole at the center of the cylindrical shape (same hereafter).

As shown in FIG. 4(b), a low relative permittivity material 3011 may have a shape corresponding to the dielectric element 1031.

(Second Embodiment)

Hereafter, the dielectric resonator according to a second embodiment of the present invention will be described by referring to the drawings.

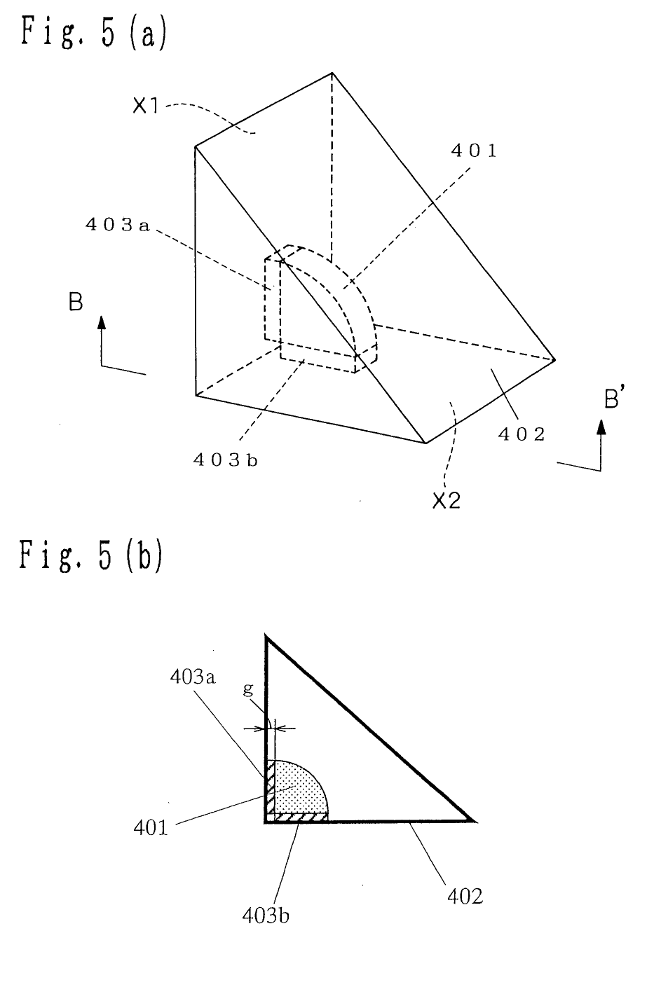

FIG. 5(a) shows a perspective view of the dielectric resonator according to the second embodiment of the present invention, and FIG. 5(b) shows a B-B′ vertical sectional view thereof.

A description of the same components as those in the first embodiment will be omitted. The input-output terminals and input-output probes will be omitted in the drawings.

Reference numeral 401 denotes a dielectric element, 402 denotes a metal housing, and 403a and 403b denote low relative permittivity materials.

The dielectric element 401 has a sectorial pole-shape obtained by quartering a cylindrical shape by two planes passing through the central axis, and the low relative permittivity materials 403a and 403b such as alumina are supported by the two severing planes of the dielectric element 401 and the metal housing 402.

To be more specific, the dielectric element 401 is compactly held at an adequate position by utilizing two adjacent housing surfaces X1 and X2 of the metal housing 402.

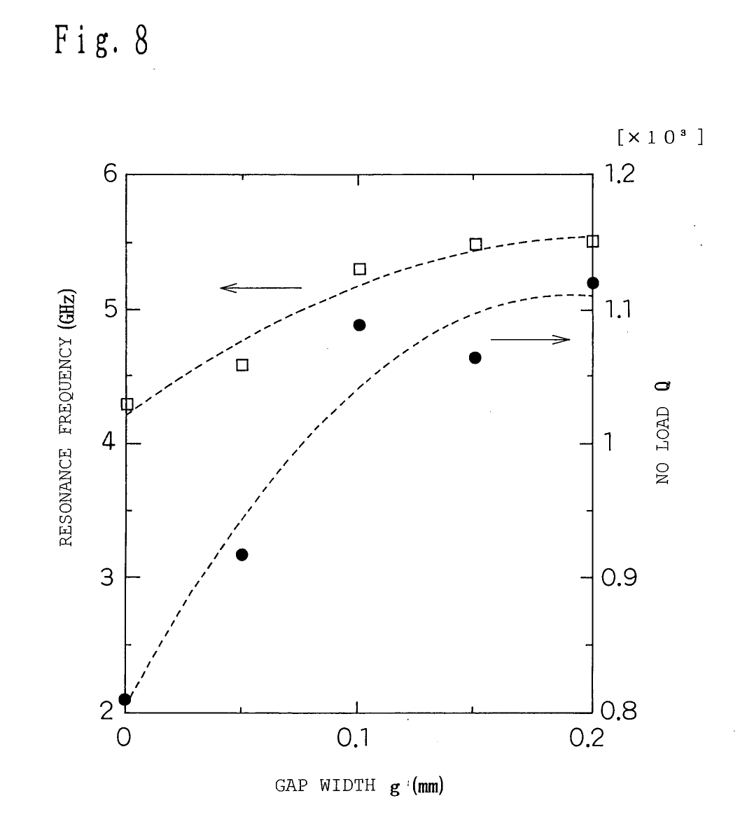

FIG. 8 is a graph (marked by black circles) plotting the relationship between the space g between the dielectric element 401 and the metal housing 402 and the value Q of the TE_{01δ}, mode dielectric resonator and a graph (marked by black squares) plotting a relationship between the space g and the resonance frequency of the TE_{01δ} mode dielectric resonator. These are the graphs in the case where the low relative permittivity materials 403a and 403b are eliminated.

As is understandable from this, the value Q of the resonator is increased by providing the space g between the quarter-cylindrical dielectric element 401 suited to miniaturization and the metal housing 402.

The shape of the dielectric element 401 is radius 5.0 mm, thickness 5.8 mm, and relative permittivity 93. As for the internal size of the metal housing 402, two orthogonal sides are 13.9 mm respectively, and one remaining side is 19.7 mm.

It is possible, by a configuration described above, to realize a small and high-Q TE_{01δ} mode dielectric resonator.

As a matter of course, the dielectric element 401 corresponds to the dielectric element of the present invention, the metal housing 402 corresponds to the housing of the present invention, and the low relative permittivity materials 403a and 403b correspond to the holding members of the present invention. The dielectric resonator according to this embodiment corresponds to the resonator of the present invention.

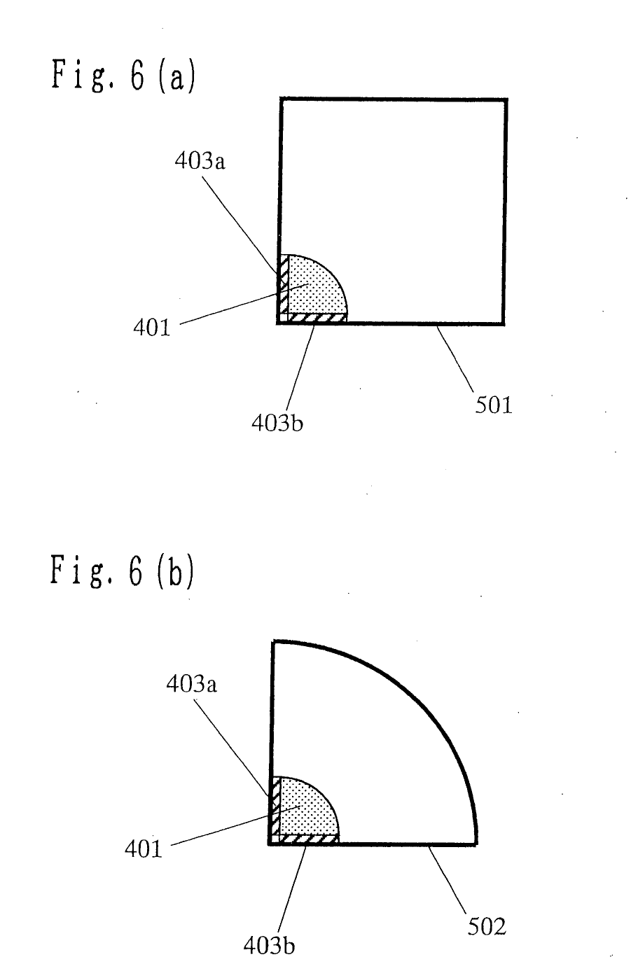

The metal housing 402 is in a triangle pole shape. It is possible, however, to obtain the same effect in the case of the rectangular solid shape as in FIG. 6(a) and in the case of the quarter-cylindrical shape as in FIG. 6(b).

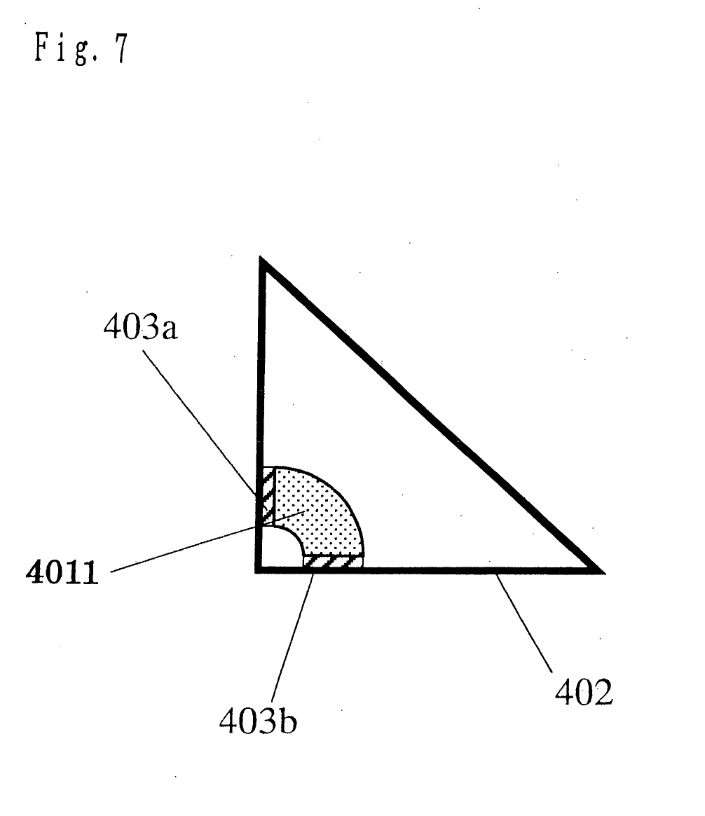

As shown in FIG. 7, the dielectric element 401 may have the quartered-doughnut shape.

(Third Embodiment)

Hereafter, the dielectric filter according to a third embodiment of the present invention will be described by referring to the drawings.

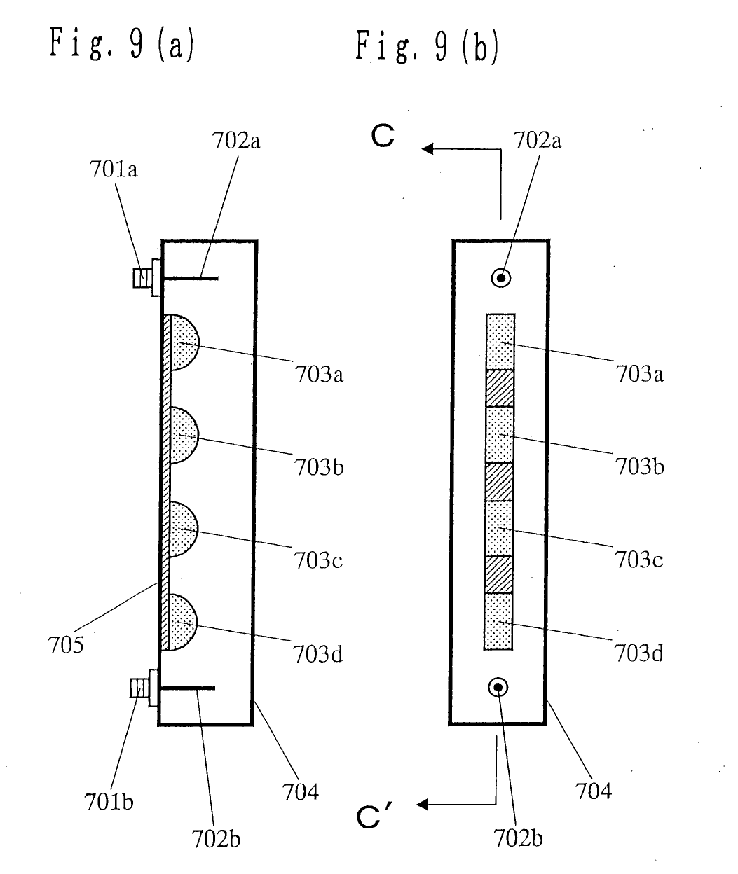

FIG. 9(a) shows a C-C′ sectional view of the dielectric filter according to the third embodiment of the present invention, and FIG. 9(b) is a right side view thereof.

The dielectric filter according to this embodiment is the four-stage filter having connected four dielectric resonators of the first embodiment.

In FIG. 9, reference numerals 701a and 701b denote the input-output terminals, 702a and 702b denote the input-output probes, 703a, 703b, 703c and 703d denote the dielectric elements, 704 denotes the metal housing, and 705 denotes the low relative permittivity material.

The input-output probes 702a and 702b are connected to the central conductors of the input-output terminals 701a and 701b by the soldering and so on respectively.

The dielectric elements 703a, 703b, 703c and 703d have the half-cylindrical shape, and the side which is the non-semicircular plane is connected to the metal housing 704 via the low relative permittivity material 705 comprised of the low relative permittivity material such as the alumina. The central axes of the half-cylindrical dielectric elements 703a, 703b, 703c and 703d are placed in parallel respectively.

Operation of the dielectric filter constituted as above will be described.

The signal inputted to the input-output terminal 701a is first outputted from the input-output terminal 701b via the electromagnetic coupling between the input-output probe 702a and the dielectric element 703a, the electromagnetic coupling between the dielectric element 703a and the dielectric element 703b, the electromagnetic coupling between the dielectric element 703b and the dielectric element 703c, the electromagnetic coupling between the dielectric element 703c and the dielectric element 703d, and the electromagnetic coupling between the dielectric element 703d and the input-output probe 702b.

Thus, the characteristic as the band pass filter can be obtained.

As described above, it is possible, according to the third embodiment, to alleviate conductor losses by placing the low relative permittivity material 705 comprised of the alumina and so on in the space g between the side which is the non-semicircular plane of the dielectric elements 703a, 703b, 703c and 703d and the metal housing 704.

It is also possible to increase the value Q of the dielectric resonator and realize a low-loss, high-performance and small filter.

It is also possible to obtain the filter having a high radiation effect of the dielectric resonator.

As a matter of course, the dielectric elements 703a, 703b, 703c and 703d correspond to the dielectric elements of the present invention, the metal housing 704 corresponds to the housing of the present invention, and the low relative permittivity material 705 corresponds to the holding member of the present invention, and the input-output probes 702a and 702b correspond to the signal input-output probes of the present invention. The dielectric filter according to this embodiment corresponds to the filter of the present invention.

The dielectric resonator according to this embodiment used the shape of the first embodiment. However, it is also possible, by using the shape of the second embodiment, to obtain a small, low-loss and high-performance filter characteristics with the high radiation effect of the dielectric resonator likewise.

One low relative permittivity material 705 was formed against the four dielectric elements 703a, 703b, 703c and 703d. It goes without saying, however, that the same effect can be obtained by forming four low relative permittivity materials to correspond to them respectively.

(Fourth Embodiment)

Hereafter, the dielectric filter according to a fourth embodiment of the present invention will be described by referring to the drawings.

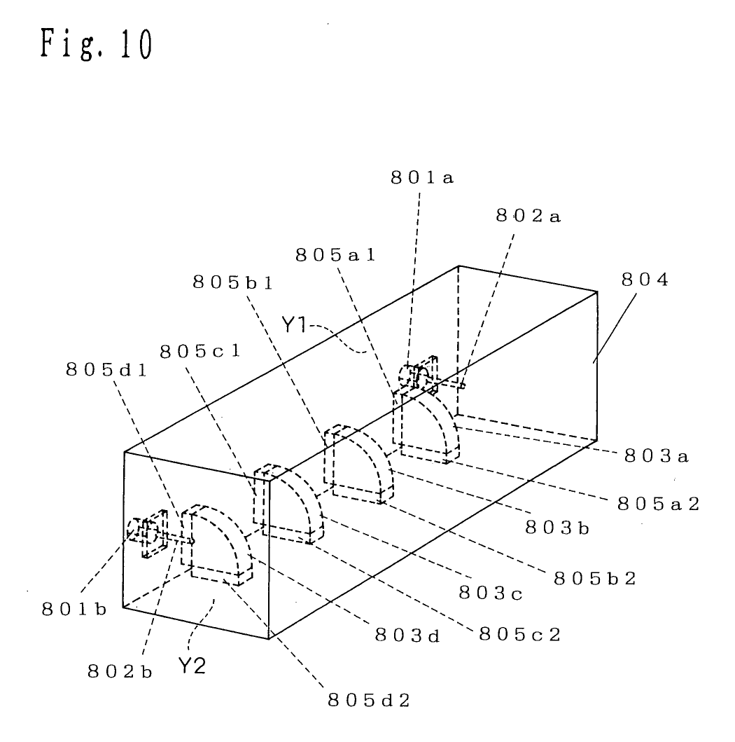

FIG. 10 shows a perspective view of the dielectric filter according to the fourth embodiment of the present invention.

The dielectric filter according to this embodiment is the four-stage filter having connected four dielectric resonators of the second embodiment.

In FIG. 10, reference numerals 801a and 801b denote the input-output terminals, 802a and 802b denote the input-output probes, 803a, 803b, 803c and 803d denote the dielectric elements, 804 denotes the metal housing, and 805a1, 805b1, 805c1, 805d1, 805a2, 805b2, 805c2 and 805d2 denote the low relative permittivity materials.

The input-output probes 802a and 802b are connected to the central conductors of the input-output terminals 801a and 801b by the soldering and so on.

The dielectric elements 803a, 803b, 803c and 803d have the quarter-cylindrical shape, and the two sides which are non-quarter-circular planes are connected to the metal housing 804 via the low relative permittivity materials 805a1, 805b1, 805c1, 805d1, 805a2, 805b2, 805c2 and 805d2 comprised of the low relative permittivity material such as the alumina.

To be more precise, the dielectric elements 803a, 803b, 803c and 803d are held by utilizing two adjacent housing surfaces Y1 and Y2 of the metal housing 804, and one of the two adjacent housing surfaces Y1 has the signal input-output terminals 801a and 801b of inputting and outputting a signal provided thereon.

The central axes of the quarter-cylindrical dielectric elements 803a, 803b, 803c and 803d are placed almost in a straight line respectively.

Operation of the dielectric filter constituted as above will be described.

First, the signal inputted to the input-output terminal 801a is outputted from the input-output terminal 801b via the electromagnetic coupling between the input-output probe 802a and the dielectric element 803a, the electromagnetic coupling between the dielectric element 803a and the dielectric element 803b, the electromagnetic coupling between the dielectric element 803b and the dielectric element 803c, the electromagnetic coupling between the dielectric element 803c and the dielectric element 803d, and the electromagnetic coupling between the dielectric element 803d and the input-output probe 802b.

Thus, the characteristic as the band pass filter can be obtained.

As described above, it is possible, according to the fourth embodiment, to alleviate the conductor losses by placing the low relative permittivity materials 805a1, 805b1, 805c1, 805d1, 805a2, 805b2, 805c2 and 805d2 comprised of the alumina and so on in the space g between the side which is the non-semicircular plane of the dielectric elements 803a, 803b, 803c and 803d and the metal housing 804.

It is also possible to increase the value Q of the dielectric resonator and realize a low-loss, high-performance and small filter.

It is also possible to obtain the filter having a high radiation effect of the dielectric resonator.

As a matter of course, the dielectric elements 803a, 803b, 803c and 803d correspond to the dielectric elements of the present invention, the metal housing 804 corresponds to the housing of the present invention, and the low relative permittivity materials 805a1, 805b1, 805c1, 805d1, 805a2, 805b2, 805c2 and 805d2 correspond to the holding members of the present invention, and the input-output probes 802a and 802b correspond to the signal input-output probes of the present invention. The dielectric filter according to this embodiment corresponds to the filter of the present invention.

The dielectric resonator according to this embodiment used the shape of the second embodiment. However, it is also possible, by using the shape of the first embodiment, to obtain a small, low-loss and high-performance filter characteristics with the high radiation effect of the dielectric resonator likewise.

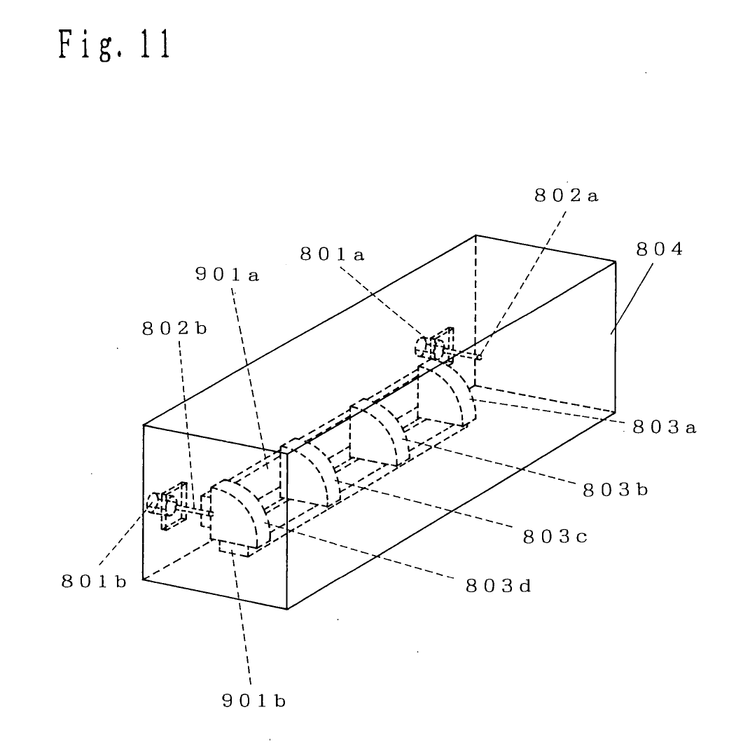

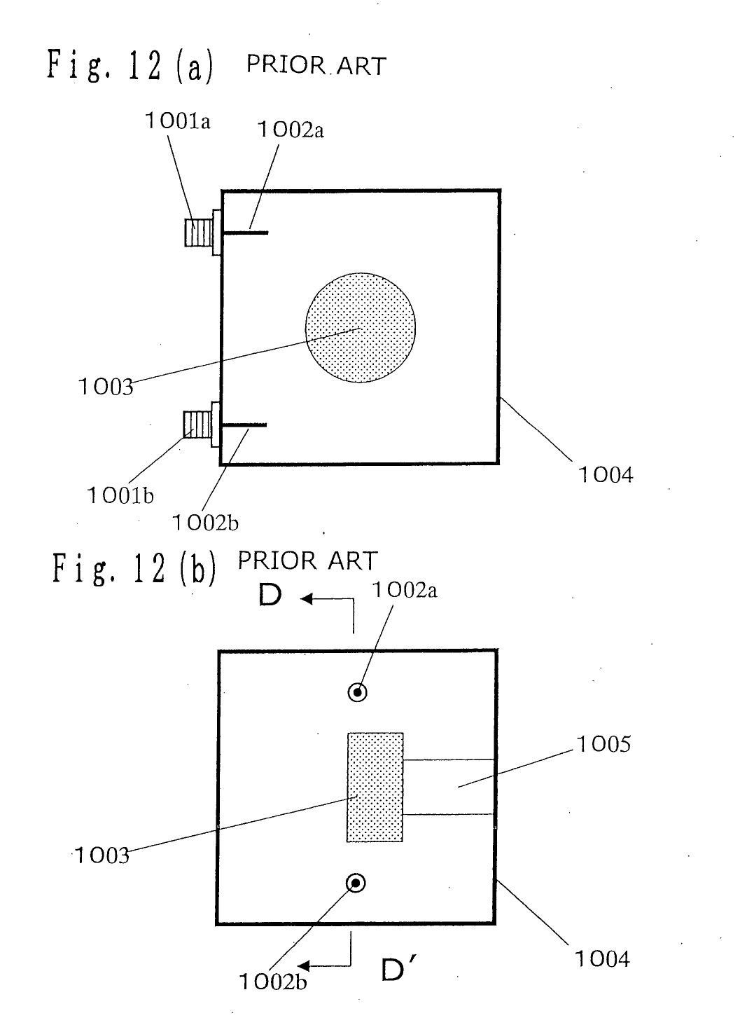

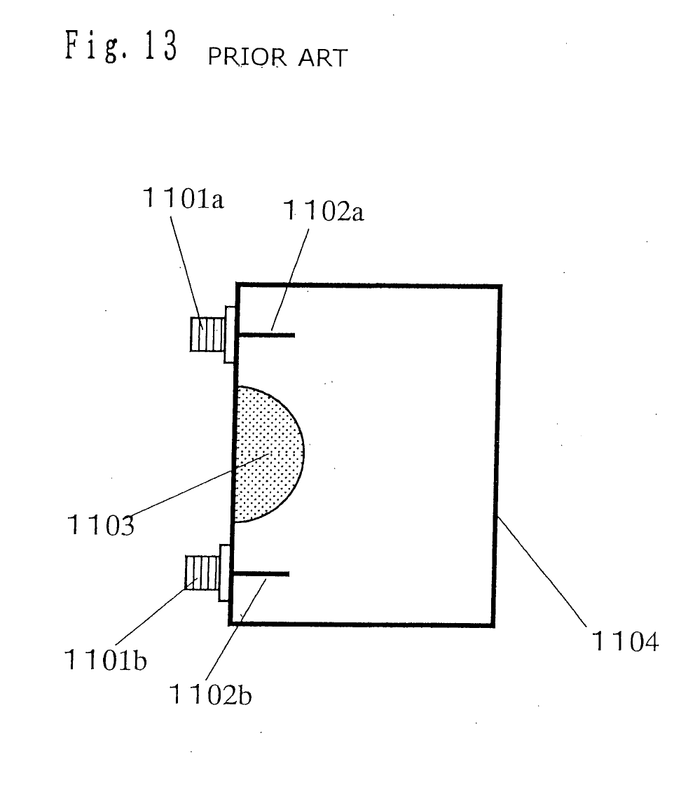

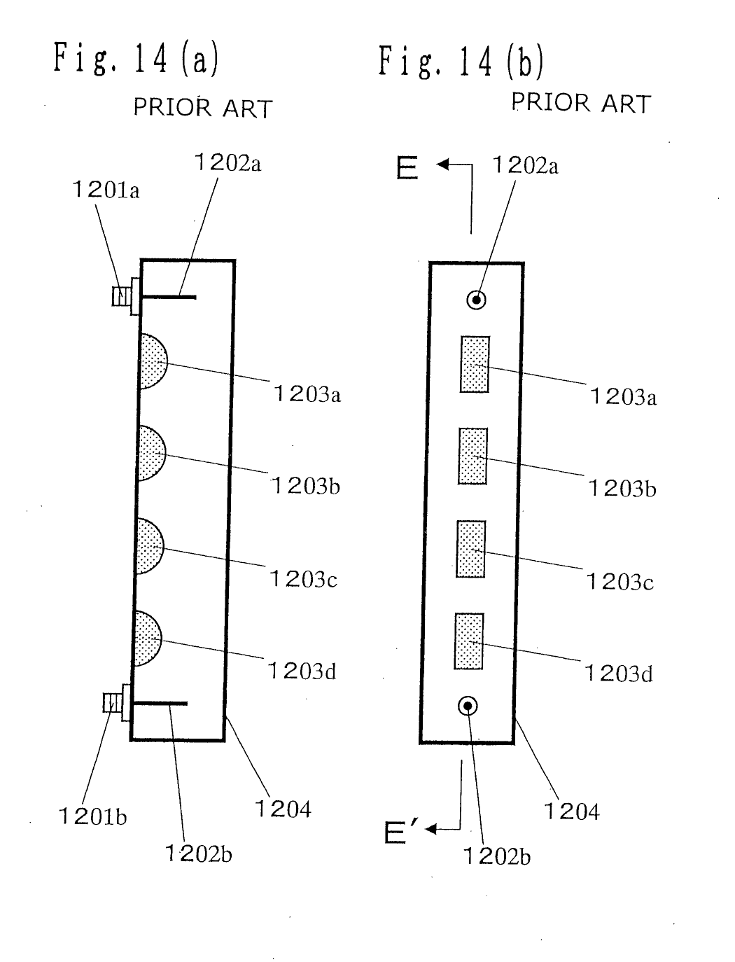

Two of each of the low relative permittivity materials 805a1, 805b1, 805c1, 805d1, 805a2, 805b2, 805c2 and 805d2 were formed against each of the four dielectric elements 803a, 803b, 803c and 803d. It goes without saying, however, that the same effect can be obtained by forming two low relative permittivity materials 901a and 901b as shown in FIG. 11.

In short, a plurality of dielectric elements of the present invention may be provided, and the holding members of the present invention may hold two or more dielectric elements in common.

As for the placement of the dielectric elements 803a, 803b, 803c and 803d, the same effect can be obtained by placing the central axes of the dielectric elements 803a, 803b, 803c and 803d in parallel as in the third embodiment.

(Fifth Embodiment)

Hereafter, the dielectric resonator according to a fifth embodiment of the present invention will be described by referring to the drawings.

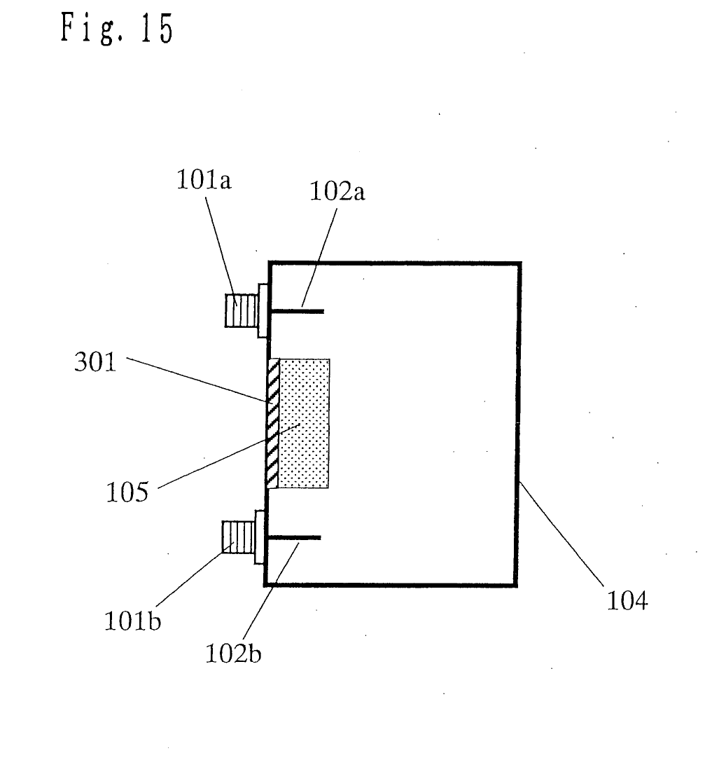

FIG. 15 shows a cross-sectional view of the dielectric resonator according to the fifth embodiment of the present invention.

A description of the same components as those in the first embodiment will be omitted.

A dielectric element 105 has a polygonal-pole-shape obtained by severing a polygonal pole shape in half by the plane going through the central axis.

To hold the dielectric element 105, the low relative permittivity material 301 made of alumina or the like is placed in the space between the side of the dielectric element 105 which is a rectangular plane and the metal housing 104.

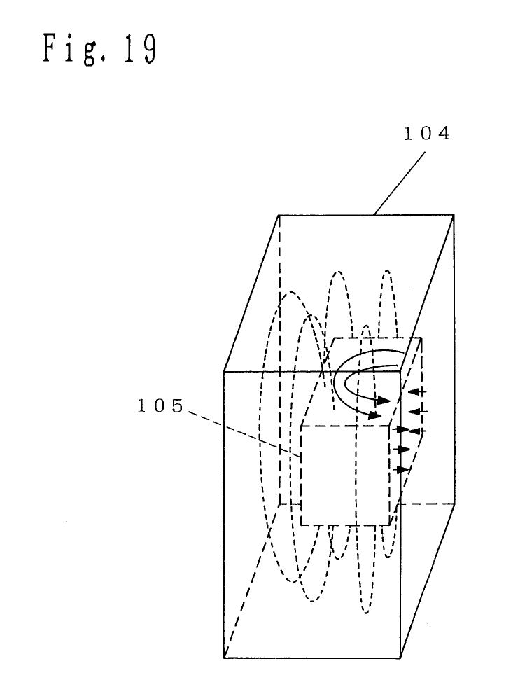

Here, as shown in FIG. 19 which is an explanatory diagram on electromagnetic field distribution generated on the dielectric resonator according to the fifth embodiment of the present invention, the electric fields (indicated in full line) are concentratedly generated inside the dielectric element 105 and in the fixed space, and the magnetic fields (indicated in broken line) are generated to be orthogonal thereto.

Thus, the configuration and operation of the dielectric resonator according to this embodiment are similar to those of the dielectric resonator according to the aforementioned first embodiment.

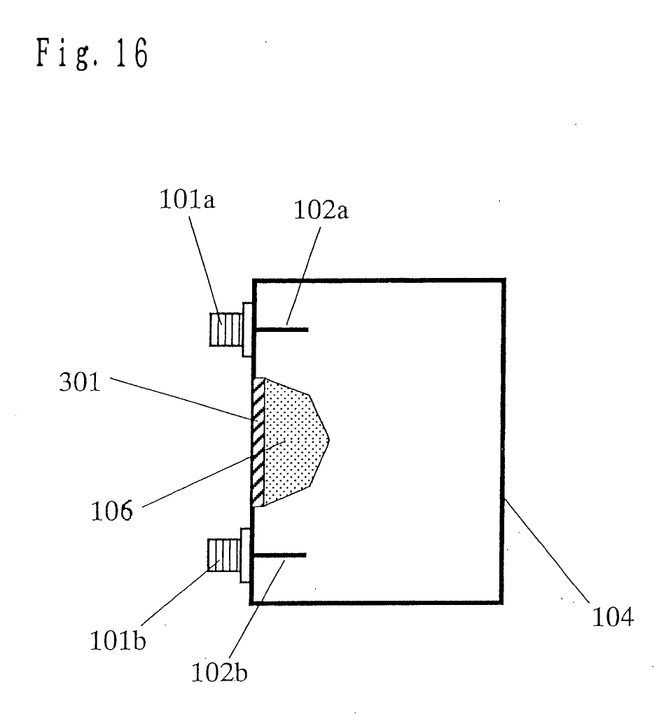

The dielectric element of the present invention was the dielectric element 105 having a square pole shape obtained by severing a square pole shape by the plane according to this embodiment. However, the dielectric resonator of the present invention is not limited thereto but may be a dielectric element 106 having a pentagonal pole shape as a result of a octagonal pole shape being severed by a plane, as shown in FIG. 16 which is a sectional view of the dielectric resonator according to the embodiment of the present invention, for instance.

As a matter of course, the dielectric element 105 corresponds to the dielectric element of the present invention. And the dielectric resonator according to this embodiment corresponds to the dielectric resonator of the present invention.

(Sixth Embodiment)

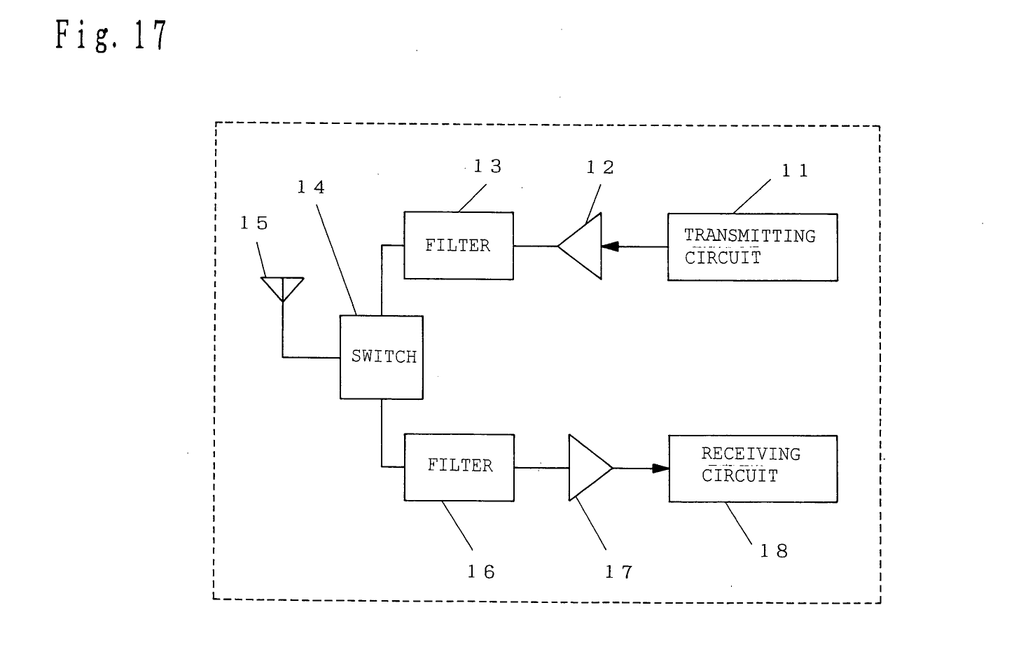

First, the configuration of a communication apparatus according to a sixth embodiment of the present invention will be described by mainly referring to FIG. 17 which is a block diagram thereof.

The communication apparatus according to this embodiment has a transmitting circuit 11 of performing transmission, a receiving circuit 18 of performing reception, a filter 13 of filtering a transmitting signal to be utilized for transmission and a filter 16 of filtering a receiving signal to be utilized for reception.

The transmitting circuit 11 is a circuit of sending the transmitting signal from an antenna 15 via a transmission amplifier 12, the filter 13 and a switch 14.

The receiving circuit 18 is a circuit of inputting the receiving signal received from the antenna 15 via the switch 14, filter 16 and a reception amplifier 17.

The filter 13 has two terminals of connecting the transmission amplifier 12 and switch 14.

The filter 16 has two terminals of connecting the reception amplifier 17 and switch 14.

Next, the operation of the communication apparatus according to this embodiment will be described.

Since a similar operation is performed for reception, the following will discuss a transmitting operation when transmission is performed.

The transmitting circuit 11 outputs the transmitting signal to be sent to the transmission amplifier 12.

The transmission amplifier 12 inputs and amplifies the transmitting signal outputted by the transmitting circuit 11, and outputs the amplified transmitting signal to the filter 13.

The filter 13 inputs and filters the amplified transmitting signal outputted by the transmission amplifier 12, and outputs the filtered transmitting signal to the switch 14.

The switch 14 inputs the filtered transmitting signal outputted by filter 13, and radio-transmits the transmitting signal from the antenna 15.

Thus, the communication apparatus according to this embodiment is a communication apparatus having one of the above-mentioned dielectric resonators or one of the above-mentioned plural-stage dielectric filters and a communication apparatus proper.

For instance, it is possible to use the above dielectric resonators and plural-stage dielectric filters for the transmitting circuit and receiving circuit of base station equipment of portable telephones and for those of terminal.

It is also possible to utilize a phase shift circuit or a shared apparatus in which the shift circuit and sending and receiving filters are combined, instead of the switch 14.

As a matter of course, the means including the transmitting circuit 11 and receiving circuit 18 correspond to transmitting and receiving means of the present invention, and the filter 13 and 16 correspond to the dielectric resonators or the filters of the present invention. And the communication apparatus according to this embodiment corresponds to the communication apparatus of the present invention.

The above described the first to sixth embodiments in detail.

According to the above described embodiments, the dielectric element of the present invention is the dielectric element operating in the TE_{01δ} mode. However, it is not limited thereto but may be the dielectric element operating in another TE mode or the dielectric element operating in a TM mode and so on for instance.

According to the above described embodiments, the electric field of the present invention is the electric field generated in the TE_{01δ} mode. However, it is not limited thereto but may be the electric field generated in another TE mode or the electric field generated in a TM mode and so on.

### ADVANTAGES OF THE INVENTION

The present invention has the advantage that it can provide the resonator, filter and communication apparatus which are small and high-Q, and the resonator manufacturing method and filter manufacturing method thereof.

What is claimed is:

1. A resonator having:
a dielectric element;
a housing of accommodating said dielectric element; and
a holding member of holding said dielectric element so as to have a predetermined clearance generated between a dielectric element surface of said dielectric element to which a generated electric field is substantially orthogonal and a housing surface of said housing opposed to the dielectric element surface.

2. The resonator according to claim 1, wherein said dielectric element is the dielectric element operating in a TE mode; and
said electric field is the electric field operating in said TE mode.

3. The resonator according to claim 1, wherein said holding member is the holding member formed in said predetermined clearance by utilizing a predetermined low relative permittivity material.

4. The resonator according to claim 1, wherein:
said dielectric element has a half-cylindrical shape obtained when a cylindrical shape is severed by a plane including its central axis; and
said dielectric element surface is a surface severed by said plane.

5. The resonator according to claim 4, further having signal input-output probes of inputting and outputting a signal provided by utilizing a housing surface on which said dielectric element is held.

6. The resonator according to claim 1, wherein:
said dielectric element has a quarter-cylindrical shape obtained when a cylindrical shape is severed by two mutually orthogonal planes including its central axis; and
said dielectric element surface is two surfaces severed by said two planes.

7. The resonator according to claim 6, wherein said dielectric element is held by utilizing two adjacent housing surfaces of said housing, and further having signal input-output probes of inputting and outputting a signal provided by utilizing one of said two adjacent housing surfaces.

8. The resonator according to claim 4 or 6, wherein said cylindrical shape has a hole at the center thereof.

9. The resonator according to claim 1, wherein:
said dielectric element has a polygonal shape obtained when a polygonal shape is severed by a plane; and
said dielectric element surface is a surface severed by said plane.

10. The resonator according to claim 9, further having signal input-output probes of inputting and outputting a signal provided by utilizing a housing surface on which said dielectric element is held.

11. A filter having:
a plurality of dielectric elements;
a housing of accommodating said dielectric elements; and
one or a plurality of holding members of holding said dielectric elements so as to have a predetermined clearance generated between dielectric element surfaces of said dielectric elements to which a generated electric field is substantially orthogonal and a housing surface of said housing opposed to the dielectric element surfaces.

12. The filter according to claim 11, wherein said dielectric elements are the dielectric elements operating in a TE mode; and
said electric field is the electric field generated in said TE mode.

13. The filter according to claim 11, wherein said holding member is the holding member formed in said predetermined clearance by utilizing a predetermined low relative permittivity material.

14. The filter according to claim 11, wherein said holding members are the holding members holding two or more of said dielectric elements in common.

15. The filter according to claim 11, wherein:
said dielectric elements have a half-cylindrical shape obtained when a cylindrical shape is severed by a plane including its central axis; and
said dielectric element surfaces are the surfaces severed by said plane.

16. The filter according to claim 15, further having signal input-output probes of inputting and outputting a signal provided by utilizing a housing surface on which said dielectric elements are held.

17. The filter according to claim 11, wherein:
said dielectric elements have a quarter-cylindrical shape obtained when a cylindrical shape is severed by two mutually orthogonal planes including its central axis; and
said dielectric element surface is two surfaces severed by said two planes.

18. The filter according to claim 17, wherein said dielectric elements are held by utilizing two adjacent housing surfaces of said housing, and further having signal input-output probes of inputting and outputting a signal provided by utilizing one of said two adjacent housing surfaces.

19. The filter according to claim 15 or 17, wherein said cylindrical shape has a hole at the center thereof.

20. The filter according to claim 11, wherein:
said dielectric elements have a polygonal pole shape obtained when a polygonal pole shape is severed by a plane; and
said dielectric element surfaces are the surfaces severed by said plane.

21. The filter according to claim 20, further having a signal input-output probes of inputting and outputting a signal provided by utilizing a housing surface on which said dielectric elements are held.

22. A communication apparatus having:
sending/receiving means of performing sending and/or receiving; and
the resonators according to claim 1 or the filters according to claim 11 of filtering a sending signal to be utilized for said sending and/or a receiving signal to be utilized for said receiving.

23. A resonator manufacturing method having a holding member formation step of forming a holding member of holding a dielectric element so as to have a predetermined clearance generated between a dielectric element surface of said dielectric element to which a generated electric field is substantially orthogonal and a housing surface of a housing of accommodating said dielectric element opposed to the dielectric element surface.

24. A filter manufacturing method having a holding member formation step of forming one or a plurality of holding members of holding a plurality of dielectric elements so as to have a predetermined clearance generated between dielectric element surfaces of said dielectric elements to which a generated electric field is substantially orthogonal and a housing surface of a housing of accommodating said dielectric elements opposed to the dielectric element surfaces.
